(19) United States
(12) Patent Application Publication
(10) Pub. No.: US 2014/0150425 A1
(43) Pub. Date: Jun. 5, 2014

(54) METHOD FOR CONTROLLING AN EXHAUST GAS RECIRCULATION SYSTEM

(71) Applicants: Patrick MENOLD, Stuttgart (DE); Rainer MAIER, Stuttgart (DE); Isabelle ELSNER, Esslingen Am Neckar (DE)

(72) Inventors: Patrick MENOLD, Stuttgart (DE); Rainer MAIER, Stuttgart (DE); Isabelle ELSNER, Esslingen Am Neckar (DE)

(73) Assignee: ROBERT BOSCH GMBH, Stuttgart (DE)

(21) Appl. No.: 14/091,209

(22) Filed: Nov. 26, 2013

(30) Foreign Application Priority Data
Dec. 3, 2012 (DE) 10 2012 222 107.7

(51) Int. Cl. F02M 25/07

(52) U.S. Cl. CPC F02M 25/0704
USPC 60/602; 60/273

(57) ABSTRACT

A method for controlling an exhaust gas recirculation system of an internal combustion engine includes: determining a setpoint power to be output by the internal combustion engine; and limiting an exhaust gas flow conducted through the exhaust gas recirculation system based on the setpoint power.

### BACKGROUND OF THE INVENTION

1. Field of the Invention

The present invention relates to a control device and a method for controlling exhaust gas recirculation systems in internal combustion engines.

2. Description of the Related Art

An internal combustion engine having a catalytic converter for a vehicle is known from Published German Patent Application document DE 10 2008 043 487 A1, whose fresh air charge may be increased via a turbocharger and whose catalytic action may be improved via an exhaust gas recirculation system.

### BRIEF SUMMARY OF THE INVENTION

According to one aspect of the present invention, a method for controlling an exhaust gas recirculation system of an internal combustion engine includes the following steps:
determining a setpoint power to be output by the internal combustion engine; and
limiting an exhaust gas flow conducted through the exhaust gas recirculation system based on the setpoint power.

The above-mentioned method is based on the consideration that, in the internal combustion engine mentioned at the outset, the turbocharger and the exhaust gas recirculation system basically derive their operating energy from the enthalpy of the exhaust gas of the internal combustion engine. Based on this fundamental consideration, it is recognized as part of the method that an activated exhaust gas recirculation system could deprive the turbocharger of the energy required for its operation, so that the internal combustion engine generates suboptimal output power.

This problem could be addressed by setpoint value specifications for the exhaust gas recirculation system and for the turbocharger, which are determined in advance under steady-state conditions on the engine test bench under various optimization criteria. The interaction between the exhaust gas recirculation system and the turbocharger would then result automatically when the setting occurs based on the setpoint value specifications.

However, it is recognized as part of the above-mentioned method that the setpoint value specifications determined under steady-state conditions on the engine test bench would be ineffective with a dynamic behavior of the internal combustion engine, such as that which may be found during transient processes, for example. In this case, both actuators, i.e., the turbocharger and the exhaust gas recirculation system, would mutually influence each other in the internal combustion engine and at a minimum noticeably delay the achievement of a steady state with the internal combustion engine.

This is where the above-mentioned method comes in since the basic problem remains unchanged. The exhaust gas recirculation system withdraws a portion of the exhaust gas, whose enthalpy would be required to drive the turbocharger. However, if the exhaust gas flow is limited by the exhaust gas recirculation system, in particular during a dynamic behavior of the internal combustion engine, accordingly more enthalpy from the exhaust gas is available for operating the turbocharger. A steady state, in which both the exhaust gas recirculation system and the turbocharger may be operated again with the above-mentioned setpoint value specifications determined on the engine test bench, may be achieved more quickly with the internal combustion engine as a result of the turbocharger now moving more freely.

In one specific embodiment of the above-mentioned method, the internal combustion engine has a turbocharger, the limitation of the exhaust gas flow through the exhaust gas recirculation system being dependent on a setpoint exhaust gas flow through a turbine of the turbocharger.

The setpoint exhaust gas flow through the turbine drives it and increases the fresh air charge in a combustion chamber of the internal combustion engine with the aid of a supercharger driven by the turbine. In this way, the required dynamics may be ensured during a charge buildup in the combustion chamber of the internal combustion engine in order to then also set a required exhaust gas recirculation rate with the aid of an improved scavenging gradient, so that, as was already mentioned, a steady state is achieved more quickly.

In one additional specific embodiment of the above-mentioned method, the setpoint exhaust gas flow through the turbine of the turbocharger is dependent on a power of the turbocharger which is required to generate the setpoint power to be output by the internal combustion engine. The setpoint power to be output by the internal combustion engine may be composed of a sum of partial powers which are influenced by various actuators in the internal combustion engine, such as a throttle valve, for example. As part of the above-mentioned method, it is possible to consider in the limitation of the exhaust gas flow only the partial power which is contributed by the turbocharger to the output of the total power of the internal combustion engine. It is thus ensured that the exhaust gas flow is limited only when this is required by the dynamics of the internal combustion engine. The limitation is then just high enough so that a required charging air pressure may be set for sufficient dynamics.

In one particular specific embodiment, the above-mentioned method includes the step of calculating the setpoint exhaust gas flow based on the required power of the turbocharger and a temperature of the exhaust gas. This specific embodiment is based on the consideration that the above-mentioned partial power dependent on the exhaust gas flow is a thermodynamic power, and hence an enthalpy flow, which is to be transmitted from the exhaust gas flow to the fresh air flow, taking into account certain losses, with the aid of the turbocharger in the internal combustion engine. At a constant temperature, this enthalpy flow is only dependent on the mass of the exhaust gas arriving at the turbocharger. Proceeding from the fact that the temperature of the exhaust gas changes at most negligibly during the dynamic behavior of the internal combustion engine, the exhaust gas mass flow required at the turbocharger may be calculated directly when the aforementioned thermodynamic setpoint power is adjusted for the temperature of the exhaust gas. If, moreover, the exhaust gas mass flow discharged by the internal combustion engine is known, it is possible, by balancing all mass flows, to calculate the exhaust gas mass flow to be set in the exhaust gas recirculation system which would be needed to ensure the exhaust gas mass flow which is required at the turbine for the partial power which is to be contributed by the turbocharger to the setpoint power to be output by the internal combustion engine.

As an alternative or in addition, the setpoint exhaust gas flow may be calculated based on one or multiple of the following variables: exhaust gas temperature, ambient temperature, ambient pressure, and pressure of the exhaust gas (32) downstream from the turbocharger (22).

The temperature of the exhaust gas may be determined in any arbitrary manner, for example based on an estimation, a measurement or a predefined value.

In one further specific embodiment, the internal combustion engine is operated in a lean operating mode. This specific embodiment is based on the consideration that the exhaust gas recirculation system could be used to lower untreated NOx emissions. To achieve a predefined dynamics during acceleration processes of the above-mentioned motor vehicle, it may be useful to transgress a required exhaust gas recirculation rate in the dynamics for a short period to then achieve the required setpoint charge in the internal combustion engine as quickly as possible, in order to then be able to set the exhaust gas recirculation rate to the target operating point. This shortens the transient states, which positively affects the emissions, the fuel consumption and driving dynamics.

In one preferred specific embodiment, the internal combustion engine may be used to drive a motor vehicle, the setpoint power being dependent on a driver's input torque for the motor vehicle.

According to one further aspect of the present invention, a control device is provided which is designed to carry out one of the indicated methods.

In one specific embodiment of the above-mentioned control device, the device has a memory and a processor. One of the above-mentioned methods is stored in the memory in the form of a computer program, and the processor is provided for carrying out the method when the computer program has been loaded from the memory into the processor.

According to one further aspect of the present invention, a computer program includes program code means to carry out all steps of one of the above-mentioned methods when the computer program is being executed on a computer or one of the above-mentioned devices.

According to one further aspect of the present invention, a computer program product includes a program code which is stored on a computer-readable data carrier and which, when the code is being executed on a data processing device, carries out one of the above-mentioned methods.

According to one further aspect of the present invention, an internal combustion engine having an exhaust gas recirculation system and a turbocharger includes an indicated control device.

### BRIEF DESCRIPTION OF THE DRAWINGS

FIG. 1 shows a schematic illustration of an internal combustion engine.

FIG. 2 shows a diagram in which a torque is plotted over the time.

### DETAILED DESCRIPTION OF THE INVENTION

In the figures, elements having identical or comparable functions are denoted by identical reference numerals and are described only once.

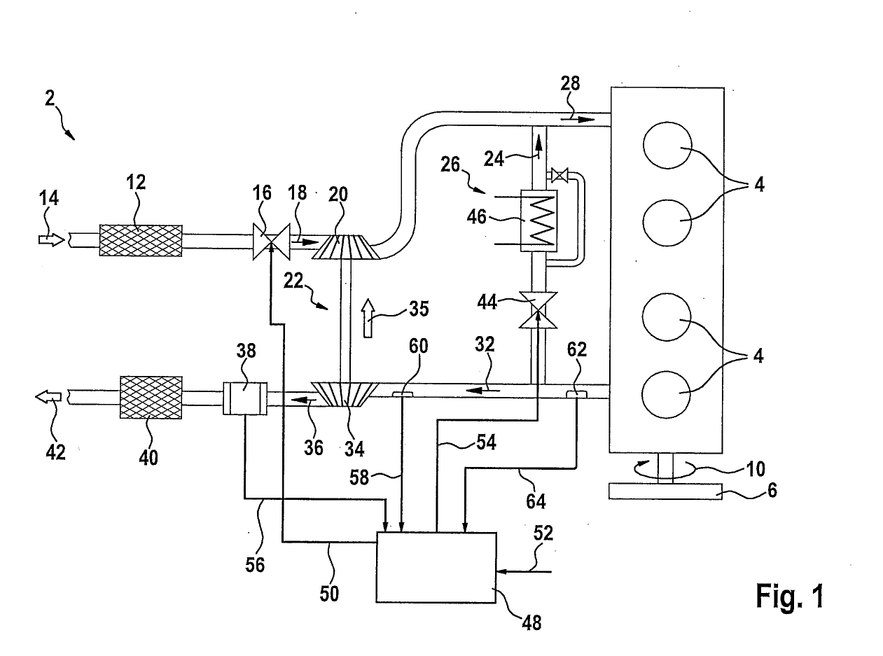

Reference is made to FIG. 1, which shows a schematic illustration of an internal combustion engine 2.

Internal combustion engine 2 may be designed as a gasoline engine or a diesel engine. Internal combustion engine 2 includes one or multiple cylinders, each having a combustion chamber 4. Fuel is injected into combustion chamber 4 in accordance with a four-stroke operation to provide a torque 10 for driving a wheel 6 of a motor vehicle which is not shown in greater detail.

For this purpose, internal combustion engine 2 takes in a fresh air flow 14, which is regulated with the aid of a throttle valve 16, via a fresh air filter 12. Regulated fresh air flow 18 is compressed with the aid of a supercharger 20 of a turbocharger 22 and mixed with an exhaust gas recirculation flow 24 from an exhaust gas recirculation system 26. Mixed air flow 28 enters combustion chamber 4 and is combusted in a manner known to those skilled in the art.

The combusted fresh air exits combustion chamber 4 in the form of an exhaust gas flow 30, a portion of exhaust gas flow 30 being conducted as above-mentioned exhaust gas recirculation flow 24 to compressed regulated fresh air flow 18 in a manner that will be described below. Remaining exhaust gas flow 32 is relaxed via a turbine 34 of turbocharger 22, turbine 34 taking up the internal energy of remaining exhaust gas flow 32, i.e., enthalpy 35, as part of the relaxation and thereby driving supercharger 20 for compressing regulated fresh air flow 18. Relaxed exhaust gas flow 36 is then discharged into the surroundings as exhaust gas 42 via a lambda probe 38 and a catalytic converter 40.

Exhaust gas recirculation system 26 has an exhaust gas recirculation valve 44, with the aid of which exhaust gas recirculation flow 24 is regulatable. A cooling device 46 is situated downstream in the exhaust gas recirculation system 26 and may be used to cool exhaust gas recirculation flow 24 in a manner known to those skilled in the art for optimal combustion in combustion chamber 4.

As mentioned above, the regulation of regulated fresh air flow 14 is carried out with the aid of throttle valve 16, which is activated by an engine controller 48 designed as an arithmetic unit using an appropriate throttle valve signal 50 based on a driver's input torque 52. Driver's input torque 52 corresponds to a value for torque 10 at which wheel 6 is to rotate.

Moreover, exhaust gas recirculation valve 44 is activated via an exhaust gas recirculation valve signal 54 based on a lambda signal 56 from lambda probe 38 in a manner known to those skilled in the art to minimize a nitrogen oxide rate in relaxed exhaust gas flow 36.

This means that turbocharger 22 and exhaust gas recirculation system 26 assume two tasks in internal combustion engine 2 which are independent of each other.

However, enthalpy 35 transmitted by turbocharger 22 is dependent on remaining exhaust gas mass flow 32 in a manner known to those skilled in the art. This means that the higher remaining exhaust gas mass flow 32 is, the higher is consequently also enthalpy 35. Consequently, remaining exhaust gas mass flow 32 is dependent on how high exhaust gas recirculation flow 24 is. During operation of internal combustion engine 2, exhaust gas recirculation system 26 and turbocharger 22 thus act counter to each other, whereby they could interfere with each other in their operation.

This problem may generally be addressed in a steady-state operation of internal combustion engine 2 by storing operating points for generating throttle valve signal 50 and exhaust gas recirculation valve signal 54 in engine controller 48, as part of which the operation of turbocharger 22 and of exhaust gas recirculation system 26 are matched to each other.

In a dynamic operation of internal combustion engine 2, i.e., when driver's input torque 52 and thus also the operating point of internal combustion engine 2 change, turbocharger 22 and exhaust gas recirculation system 26 must first adjust to one of the operating points stored in engine controller 48. This may take a very long time, depending on the circumstances, due to the two tasks of turbocharger 22 and exhaust gas recirculation system 26 being independent of each other.

To still address the above-described problem mentioned as part of the dynamic operation of internal combustion engine 2, internal combustion engine 2 should adjust to a new operating point as quickly as possible. To make this possible, the present embodiment provides for limiting the degree of freedom of internal combustion engine 2 in the short term and for limiting the freedom of one of the two actuators (turbocharger 22 or exhaust gas recirculation system 26). Since turbocharger 22 has influence on the adjustment to an operating point, while exhaust gas recirculation system 26 does not, the freedom of exhaust gas recirculation system 26 should be limited.

To minimize this limitation of the freedom of exhaust gas recirculation system 26 to the extent possible, it is provided as part of the present embodiment to limit exhaust gas recirculation valve signal 54 as a function of enthalpy 35 which is necessary to ensure that internal combustion engine 2 freely adjusts to a new operating point during dynamic operation. For example, this necessary enthalpy 35 may be determined by balancing a setpoint enthalpy for regulated fresh air flow 18 for implementing driver's input torque 52 and an actual enthalpy of regulated fresh air flow 18, which is dependent on a throttle valve signal 50, for example.

If necessary enthalpy 35 is known, the same may be converted into a required value for remaining exhaust gas flow 32 based on a temperature 58 of remaining exhaust gas flow 32 detected with a temperature sensor 60 or in any other arbitrary manner. If, finally, combusted mass flow 64 which is discharged from combustion chamber 4 is detected via a mass flow sensor 62, it is possible, once again with the aid of balancing this mass flow 64 with the required value for remaining exhaust gas flow 32, to determine how high the maximum exhaust gas recirculation flow 24 may be so that required enthalpy 35 may be transmitted to supercharger 20.

Engine controller 48 may then accordingly generate exhaust gas recirculation valve signal 54 to limit exhaust gas recirculation flow 24 accordingly to this maximum value using exhaust gas recirculation valve 44.

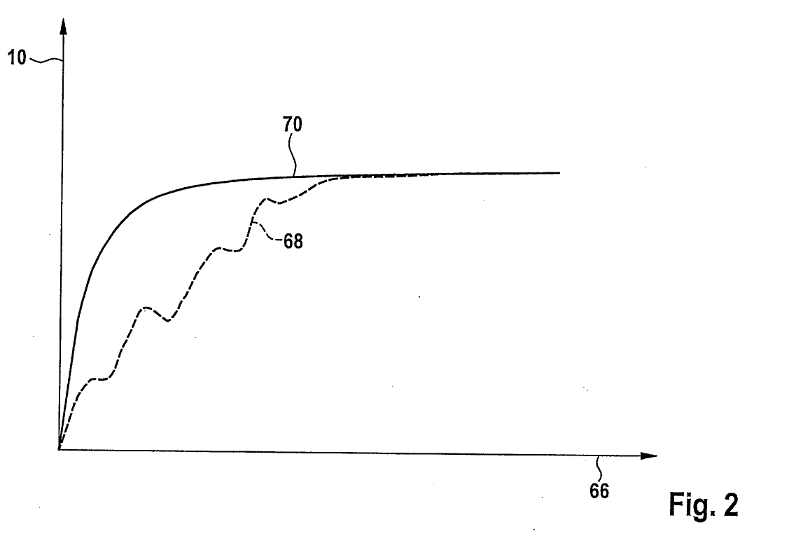

Reference is made to FIG. 2 which illustrates torque 10 over time 66.

The curves shown in FIG. 2 represent the progression of torque 10 over time 66 following a change in the operating point of internal combustion engine 2, for example as part of a changed driver's input torque 52.

Curve 68 in the dotted line shows the chronological progression of torque 10 if exhaust gas recirculation flow 24 is not limited to new driver's input torque 52 as part of the adaptation of torque 10, while curve 70 in the solid line shows the chronological progression of torque 10 if torque 10 is limited to new driver's input torque 52 as part of the present embodiment.

As soon as torque 10 has stabilized again to new driver's input torque 52, the limitation of exhaust gas recirculation flow 24 may be lifted.

What is claimed is:

1. A method for controlling an exhaust gas recirculation system of an internal combustion engine, comprising:
determining a setpoint power to be output by the internal combustion engine; and
limiting an exhaust gas flow conducted through the exhaust gas recirculation system based on the setpoint power.

2. The method as recited in claim 1, wherein the internal combustion engine includes a turbocharger, and the limitation of exhaust gas flow through the exhaust gas recirculation system is dependent on a setpoint exhaust gas flow through a turbine of the turbocharger.

3. The method as recited in claim 2, wherein the setpoint exhaust gas flow through the turbine of the turbocharger is dependent on a power of the turbocharger which is required to generate the setpoint power to be output by the internal combustion engine.

4. The method as recited in claim 3, wherein the setpoint exhaust gas flow is calculated based on the required power of the turbocharger and at least one of a temperature of the exhaust gas, an ambient temperature, an ambient pressure, and a pressure of the exhaust gas downstream from the turbocharger.

5. The method as recited in claim 4, wherein the temperature of the exhaust gas is one of (i) an estimated value, (ii) a measured value, or (iii) a predefined value.

6. The method as recited in claim 4, wherein the internal combustion engine is operated in a lean operating mode.

7. The method as recited in claim 4, wherein the internal combustion engine powers a motor vehicle controlled by a driver, and wherein the setpoint power is dependent on the driver's input torque for the motor vehicle.

8. A control device for controlling an exhaust gas recirculation system of an internal combustion engine, comprising:
means for determining a setpoint power to be output by the internal combustion engine; and
means for limiting an exhaust gas flow conducted through the exhaust gas recirculation system based on the setpoint power.

9. A non-transitory computer-readable data storage medium storing a computer program having program codes which, when executed on a computer, performs method for controlling an exhaust gas recirculation system of an internal combustion engine, the method comprising:
determining a setpoint power to be output by the internal combustion engine; and
limiting an exhaust gas flow conducted through the exhaust gas recirculation system based on the setpoint power.
